(19) United States
(12) Patent Application Publication
(10) Pub. No.: US 2016/0032946 A1
(43) Pub. Date: Feb. 4, 2016

(54) ROTATIONAL SPEED LIMITATION DEVICE FOR A MOTOR

(71) Applicant: Danfoss Power Solutions GmbH & Co. OHG, Neumunster (DE)

(72) Inventors: Bernd Hames, Henstedt-Ulzburg (DE); Andreas Schumacher, Hamburg (DE)

(21) Appl. No.: 14/810,560

(22) Filed: Jul. 28, 2015

(30) Foreign Application Priority Data
Jul. 30, 2014 (DE) 102014011073.7

(51) Int. Cl. F15B 11/042; F16H 61/4052; F16H 61/4035

(52) U.S. Cl. CPC F15B 11/0423; F16H 61/4035; F16H 61/4052

(57) ABSTRACT

Hydraulic motor for driving a work equipment comprising a hydraulic drive mechanism with a high pressure side and a low pressure side. On the low pressure side a first throttle orifice and a second throttle orifice within a first bypass line bypassing the first throttle orifice are arranged, whereby at least the throttle orifice opening of the second throttle orifice is adjustable.

### CROSS REFERENCE TO RELATED APPLICATION

Applicant hereby claims foreign priority benefits under U.S.C. §119 from German Patent Application No. DE 102014011073.7 filed on Jul. 30, 2014, the contents of which are incorporated by reference herein.

### TECHNICAL FIELD

The invention relates to a device, respectively to an arrangement for the limitation of the rotational speed of a hydraulic motor, respectively for a driving mechanism of the hydraulic motor. The invention relates further to a hydraulic motor arranged in a hydrostatic transmission comprising an open or closed hydraulic fluid circuit.

### BACKGROUND

Hydrostatic motors are often used for driving working equipments which are not always capable to release the energy supplied by a hydraulic pump completely at any time, for instance a rotational energy if the drive shaft of the hydraulic motor is blocked. In that case hydraulic energy is accumulated within the hydrostatic transmission as potential energy, for instance, in the form of compressed hydraulic fluid or expansion of the lines conducting the hydraulic fluid. Exemplarily this is the case with drives of drill strings, in particular, for ground drillings if the drill head or a reamer device for expanding bore holes gets sticked or interlocked. In ground drillings often unexpected and not predictable high resistance occurs which also unexpectedly, i.e. suddenly, disappear if the drill string breaks away or if the drill tears off. If, for instance, a drill bit hits a relatively big stone in the ground the rotational speed of the ground drill string is reduced abruptly, what in an extreme case could lead to a short blockade of the drive shaft. However, the drill string often breaks free exemplarily by sheering off the resistance, for instance a root or by breaking away/breaking loose a stone. The potential energy accumulated before is now released abruptly as the resistance at the drill string disappears for a short time nearly completely—until another resistance appears. In this time period the resistance at the drive shaft is nearly cero and the hydraulic motor can accelerate undamped, what in the worst case, leads to over-speeding and therewith to damages on the hydraulic motor, respectively on its drive mechanism. Furthermore, another effect especially with drill strings occurs which additionally accelerates the hydraulic motor after the disappearance of the resistance. During the drilling operation the drill string is twisted, what increasingly occurs if the drill bit encounter a relative big resistance reducing the drill rotational speed. After a break-away of the drill bit from the resistance the potential energy stored due to twisting is able to accelerate the hydraulic motor via the drill string which hydraulic motor shortly acts as hydraulic pump and can cause further damages on a working equipment.

From EP 0 906 811 B1 a hydraulic drill hammer is known whereby in each of the pressure lines towards the hydraulic motor an orifice and parallel hereto a check valve is arranged. Hereby the orifices serves each for separate adjustment of the flow rate amount in both rotational directions of the hydraulic motor. In EP 0 906 811 B1 in fact it is mentioned that the drill string can be locked in the rocks and that following to this the hammer mechanism is stopped, however, EP 0 906 811 B1 gives no hint thereto that a measure is necessary to prevent a rev up of the hydraulic motor if the blocking of the drills string after a break free is terminated.

In EP 0 337 124 B1 a hydraulic motor is described in whose low pressure line an orifice with a fixed orifice opening is arranged. Hereby it should be achieved that the casing of the hydraulic motor is freed from unadmissible high pressures. Such pressures could occur, for instance if the hydraulic fluid at low temperatures comprises a high viscosity.

### SUMMARY

It is therefore object of invention to provide a device with which such a non-intended and non-controlled rev up of a driving mechanism of a hydraulic motor can be prevented and with which an effective overspeed protection for a drive mechanism of a hydraulic motor is provided. Thereby it is another object of the invention to provide an extreme quick reacting system which controls and prevents in a reliable manner the increase of rotational speed at the drive mechanism of a hydraulic motor and prevents the drive mechanism to reach overspeed. Further the device should be designed robust as well as the manufacturing costs should be realized costeffective without an additional high number of parts necessary.

The object is solved by a hydraulic motor for driving a working equipment, with a drive mechanism comprising a high pressure side and a low pressure side whereby on the low pressure side a first throttle orifice and a second throttle orifice within a bypass line which bypasses the first throttle orifice are arranged, whereas at least the orifice opening of the second throttle orifice is adjustable.

Within the framework of the description of the invention as an representative embodiment for all common applications for work equipments in the art a ground drill device is used. However, the scope of the inventive idea covers all by means of a hydraulic motor, respectively by means of the drive mechanism of a hydraulic motor drivable work equipments whereby (saltational) discontinuities in the external load during operation can occur. Such discontinuities can be load peaks and load throughs temporarily existing but also exemplarily sudden part-failure, for instance clutch failure or tear-off of a screwhead at a screw operation or the spinning off of the driving wheels of a traveling mechanism. Therefore the invention is for mere clearness purposes described exemplarily with the help off a drilling device for ground drillings what, however, do not limit the scope of the inventive idea.

The inventive hydraulic motor for driving a working equipment comprises a hydraulic drive mechanism having necessarily as all usual drive mechanisms a high pressure side and a low pressure side. According to the invention on the low pressure side, for instance in a low pressure line a first orifice is arranged being bypassed by a bypass line. In the bypass line a further second orifice is arranged. At least one of both orifices is adjustable with regard to its orifice opening during the operation of the drive mechanism of the hydraulic motor.

Preferred further, the orifice opening of one of both orifices is set fixedly during the operation of the work equipment that means that the orifice opening is adjusted preferable independent from the external load on the hydraulic motor, respectively on the driving mechanism or the work equipment. However, in a preferred embodiment the orifice opening of the static orifice is exemplarily adaptable to the rotational speed or to the displacement angle of the hydraulic motor.

The second orifice is adjustable variably, preferably during the operation of the hydraulic motor and is capable to increase or reduce the resistance on the low pressure side of the driving mechanism depending on the behavior of the external load at the driving shaft of the hydraulic motor. Thereby, the second orifice is implemented preferably as a metering orifice. Its orifice opening can be adjusted during the operation of the hydraulic motor in the way of a flow control valve by means of the varying low pressure being present downstream after the drive mechanism or upstream before the metering orifice, respectively. Hereby, the pressure acts preferably against an orifice spring intending to hold the orifice cross section maximally opened. If the low pressure or the amount of hydraulic fluid being conveyed by the drive mechanism of the hydraulic motor towards a hydraulic pump at the outlet of the drive mechanism increases saltational the pressure at the metering orifice also raises abruptly whereas, according to the invention, the spool of the metering orifice forced by an increased closing hydraulic force closes the orifice opening of the metering orifice against the spring force. In this way the metering orifice is self-actingly lowered in its orifice cross section what means its orifice opening is reduced. By reducing the orifice opening, the resistance at the low pressure side of the drive mechanism raises, hence the hydraulic motor have to work against this increased resistance. A load-free runaway is thereby prevented.

Imaginating a load condition as it often occurs exemplarily with ground drillings in which a drill string pipe exemplarily seizes in the ground and is released suddenly by braking or tearing off from stones or branches, thereby causing severe consequences on the pressures in the interior of the hydraulic motor. Meanwhile, the drill string pipe sticks or seizes in the ground the hydraulic pump continues generating a hydraulic fluid flow rate towards the hydraulic motor which cannot be transformed sufficiently by the hydraulic motor into rotation energy. Consequently, in particular, dynamic pressures within the motor and within the hoses, exemplarily connecting the hydraulic pump with the hydraulic motor. Thereby, not only the force at the hydraulic motor raises since the increase of force occurs also very abrupt, i.e. saltational, whereby in most of the cases it comes to a braking away of the drill bit which is able to speed up nearly without any resistance after such a “breaking through” of the resistance unless he encounters a new resistance. The hydraulic motor is able to speed up saltationally, as the work equipment is able now to turn nearly without any load. It might come to an over-speeding of the drive mechanism what is, according to the invention, prevented by that a quick increase of the rotational speed of the drive mechanism causes also the conveying volume flow rate to increase abruptly at the outlet of the drive mechanism. The variable adjustable orifice used according to the invention, preferable a metering orifice detects the increased hydraulic fluid volume flow rate and reduces in reaction to such an increased hydraulic fluid flow rate the throttle cross section and, therewith, increase the resistance on the outlet side, that means at the low pressure side of the drive mechanism of the hydraulic motor. Therewith, it is prevented that the hydraulic motor after a break free is enabled to speed up unhindered (nearly free of any load) because the hydraulic motor will be braked by the increase of the resistance on the low pressure side. Now he has to work against this resistance and therefore he cannot turn “freely”. According to the invention, by this a effective and very quick reacting device is provided which prevents the hydraulic motor, respectively the drive mechanism of the hydraulic motor to come into an over-speed range, if the external load suddenly breaks away.

In a further embodiment the orifice opening of the second variable orifice is adjustable by means of an actuator, which is operable exemplarily by a control unit mechanically, hydraulically, electrically or pneumatically. By for instance, a sensor detecting an excessive increase of the hydraulic fluid flow rate at the outlet, the control unit receives a corresponding signal for activating the actuator. The actuator itself can act for example mechanically, hydraulically, electrically or pneumatically on the metering orifice spool and is able to reduce the orifice opening accordingly. According to the invention it can be thought as well in a sensor controlled actuator which exemplarily detects the increase of the rotational speed at the drive shaft of the driving mechanism and which reduces the orifice opening accordingly if an inadmissible high rotational speed increase during a time unit occurs. For a person skilled in the art it is obvious that a plurality of further possibilities of detection and controlling of the actuator is imaginable which—however covered entirely by the inventive idea—achieve that the hydraulic resistance at the outlet side of the drive mechanism of the hydraulic motor is raised by means of reducing the orifice opening of the parallel arranged orifices in order to prevent an over-speeding of the hydraulic motor.

Which system is used hereby depends on the application, i.e. which work equipment is driven by the inventive hydraulic motor. In particular, with ground drill equipments a quick reaction after a break free of a sticked drill bit or after sticking of a reaming device for expanding a ground bore hole is required, however. These devices which often are operated with hydraulic transmissions at high power, the increase of the rotational speed at the moment of disappearing of the resistance at the drilling device proceeds very, very sharp such that within a few msec. an excess of rotational speed can be reached by the driving mechanism. Therefore, preferably with ground drill equipments a self-adapting hydraulically adjustable metering orifice will be used, which reacts nearly without time losses on variations in the hydraulic fluid flow rate downstream of the drive mechanism, especially in consequence that its signal ways could be designed very short.

In further embodiments, hydraulic motors according to the invention are used whose absorption volume is adjustable, what means that their rotational speed, respectively their torque, is adjustable via the absorption volume. Especially, in the case in which high rotational speeds are required, the absorption volume is low, however, at high rotational speeds also the distance to a critical rotational speed is lower whereas in case of disappearing of the external load an extreme quick and effective limiting of the increase of the rotational speed has to be achieved. Thereby, the increase of the absorption volume for reducing the rotational speed is not the appropriate measure as this benefits the increase of the rotational speed as with the increase of the absorption volume the torque increases and if the external load is nearly not existent also the increase of the rotational speed. Here, the increase of the resistance at the outlet of the drive mechanism is the more appropriate measure to prevent over-speed.

In a lot of applications for hydraulic motors, propulsion in both rotational directions is required such that the used hydraulic motor must be reversible with regard to its rotational direction, i.e. it should provide a clockwise as well as a counterclockwise rotation. In the example for ground drill applications, one rotational direction is used for drilling or extracting the drill string pipe out of the bore hole and the other rotation direction is used for elongation or shorten the drill string pipe. Hereby, the drill string pipe can get catched by the soil whereas the above described load peaks and subsequent load through can occur which can lead to an over-speed of the hydraulic motor if the drill string pipe tears free. The change of the rotation direction at a hydraulic motor is exemplarily done by the hydraulic motor itself as the hydraulic motor can be displaced in both directions starting from a neutral position such that the hydraulic motor with unchanged flow direction in the hydraulic circuit can turn clockwise or counterclockwise. In this case—as the flow direction in the hydraulic circuit is unchanged—the high pressure side and the low pressure side at the drive mechanism maintains unchanged.

In other applications, respectively in other hydrostatic drives, the direction of rotation of the hydraulic motor can be done by adequate displacement or shifting of the hydraulic pump as the hydraulic pump starting from a neutral position is displaceable in both directions and therewith the conveying volume flow rate through the hydrostatic transmission respectively through the closed hydraulic circuit changes its direction of flow. In this case hydraulic motors are used which are solely displaceable to one side and which exemplarily can be displaced only one-sided into a maximum position starting from a neutral position whereby the changing flow direction within the hydraulic lines causes that the hydraulic motor turn clockwise or counterclockwise. In this case by the amendment of the rotation direction also the high pressure side and the low pressure side at the hydraulic motor changes. To prevent that the hydraulic motor solely adjustable to one side reaches neither in the clockwise nor in the counterclockwise direction over-speed, each side can be provided with an inventive throttle system or an inventive throttle arrangement, respectively. However, on the respective high pressure side, the throttle arrangement must be non-active in order to prevent damages at the hydraulic motor due to lack of supply. The inactive switching of the throttle orifice arrangement on the high pressure side prevents further loss of energy of the hydraulic energy provided by the pump.

In an alternative of the invention the throttle orifice arrangement is switched non-active exemplarily by a bypass line in which a check valve is arranged. The check valve on the high pressure side opens in the direction of flow such that the hydraulic fluid flow rate coming from the hydraulic pump can act on the driving mechanism of the hydraulic motor and the hydraulic power can be transformed by the drive mechanism into a rotational drive. At the same time the check valve likewise arranged at the low pressure side in a bypass line is closed whereby the hydraulic fluid flow rate dispensed off by the hydraulic motor have to flow over the inventive arranged orifices. Hereby, the resistance at the outlet side, i.e. at the low pressure side of the drive mechanism can be controlled according to the invention whereby the above described rotational speed limitation for the motor is achieved. Therewith, the arrangement with another bypass line for bypassing the inventive orifice arrangement and with a check valve arranged therein represents thus a self-acting system which autonomously according to the rotational direction of the drive mechanism of the hydraulic motor switches the high pressure side hydraulically without resistance and provides on the low pressure side an adjustable hydraulic resistance.

Instead of two bypass lines for bypassing the orifice arrangement one of the two orifices can be arranged in a shuttle valve, which according to the rotational direction of a single side adjustable motor can be shifted in the position in which the hydraulic resistance is as low as possible or in which the hydraulic resistance is adjustable by the inventive orifice arrangement. Such a shuttle valve comprises a valve spool which exemplarily is brought by a shuttle valve spring in a position in which the shuttle valve is opened maximally if the hydraulic forces acting in opposite directions on it canceling out each other or if their difference is lower than the force of the valve spring. The two hydraulic forces are generated by pressures being present before or after the shuttle valve what means at its inlet or outlet. Preferably the pressure at the hydraulic motor side acts on the shuttle orifice cross-section-reducing and the one on the backside of the hydraulic motor acts valve-opening. Therewith the opening cross section of the adjustable orifice is self-actingly adjusted by means of the pressure gradient on both sides of the shuttle valve orifice.

In a hydrostatic transmission in which the hydraulic motor is displaceable only single sided and the change of rotational direction is done by a change of flow direction of the hydraulic fluid in the hydraulic circuit, preferably two shuttle valves are used, each on one side of the hydraulic motor. Each of the two shuttle valves are in a different switch position that means one of the two shuttle valves—the one on the high pressure side—is in a first position, in which the cross section through the valve is freed maximally and the second shuttle valve—the one on the low pressure side—provides an orifice, being appropriately adjustable by the hydraulic fluid flow rate at the outlet of the driving mechanism. However, a static orifice being switched into the correspondent hydraulic line by the shuttle valve is also imaginable, which static orifice is adaptable to the application for which the hydrostatic transmission is provided for, or is adaptable or adjustable with regard to the work machine.

As already mentioned above, in the inventive arrangement two parallel orifices can be used in an open hydraulic fluid circuit as well as in a closed hydraulic fluid circuit whereby at least one is hydraulic fluid flow-rate-controlled by the present hydraulic fluid flow rate. Not relevant for the invention is the type of hydraulic motor on which the inventive arrangement is applied whether it is an axial piston motor or a radial piston motor. If axial piston motors are used which normally are running relatively quick in comparison to radial piston motors, axial piston motors of the bent axis construction type as well as of the swashplate construction type can be provided with the inventive orifice arrangement. With the inventive overspeed protection for hydraulic motors it is not relevant if the external load disappears from a hydraulic motor in radial piston construction type or axial piston construction type. If the external load is virtually nearby cero both construction types rapidly reach a high rotation speed range whereas radial piston motors depending on their construction type tolerates only lower rotational speeds as axial piston motors and, thus, eventually may be more in jeopardy of overspeeding. However, the increase of the rotational speed of radial piston motors is normally more gently as the one of axial piston machines as radial piston motors according to their construction type are reacting slowlier.

### BRIEF DESCRIPTION OF THE DRAWINGS

In the following, with the help of Figures, preferred embodiments of the invention are shown, however, they do not limit the inventive idea. It is shown in:

FIG. 1 a first embodiment according to the invention;

FIG. 2 a second embodiment of the invention; and

FIG. 3 a third embodiment according to the invention.

### DETAILED DESCRIPTION

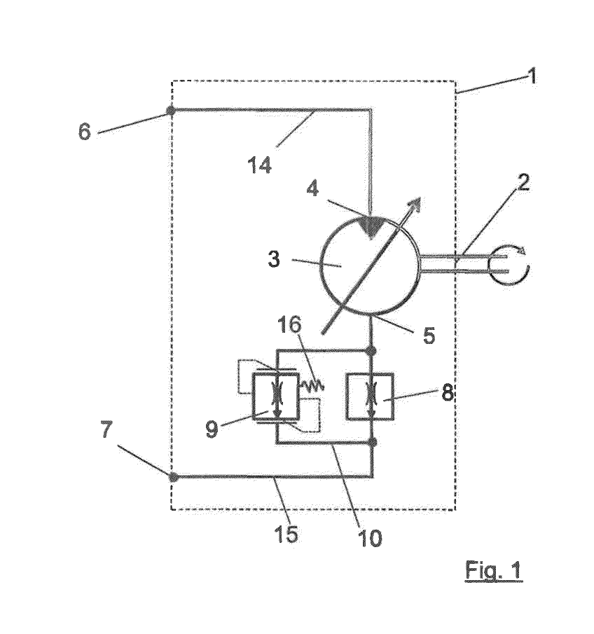

FIG. 1 shows a hydraulic motor 1 comprising a drive mechanism 3 having in drive operation a high pressure side 4 and a low pressure side 5. The drive mechanism 3 is connected exemplarily by means of a high pressure line with a hydraulic pump (not shown). Analogously, the drive mechanism 3 is connected with the same hydraulic pump via a low pressure port 7, if it is a closed circuit. However, the inventive idea covers open circuits as well. In this case the low pressure port 7 may be connected exemplarily with a tank. FIG. 1 shows a hydraulic motor 1 being drivable only in one rotation direction and whose adjustable drive mechanism 3 is capable to drive exemplarily a working equipment by the means of a driving shaft 2.

On the low pressure side 5 of drive mechanism 3 in the low pressure conducting line 15 connecting the drive mechanism 3 with port 7 a first static orifice 8 is arranged being bypassed by a first bypass line 10. In the first bypass line 10 a further second orifice 9 is arranged which is adjustable exemplarily in its throttle cross section or in its orifice opening. If both orifices are opened maximally hydraulic fluid flow dispensed by the driving mechanism 3 of the hydraulic motor 1 can flow back to the hydraulic pump in a generally unhindered manner. If the orifice cross section at one of both orifices is reduced, the dynamic pressure before the orifice rises and the drive mechanism 3 of the hydraulic motor 1 have to convey the supplied hydraulic fluid against a higher resistance. This causes a rotation speed reduction at drive mechanism 3. This effect is used by the invention in case, if an external load on hydraulic motor 1 disappears abruptly.

If for instance driving shaft 2 is connected to a soil drill string pipe foreseen to generate a bore hole into the soil, it often happens that the drill bit is slowed by stones or similar in its rotation motion, whereas at the drive mechanism an increased (dynamic-)pressure is generated which is being absorbed by a compression of hydraulic fluid, respectively, by the expansion of the hydraulic fluid hoses and is stored as potential energy in the hydrostatic transmission. If the drill bit breaks free the potential energy drives the driving mechanism 3 additionally to the energy supplied by the hydraulic pump. At the same time the external load is shortly after the break-free often very low or virtually cero such that drive mechanism 3 nearly without resistance can speed up driven by both energies whereby a overspeeding of drive mechanism 3 of hydraulic motor 1 is possible. Due to the saltational increase of the rotational speed at drive mechanism 3 of hydraulic motor 1 an increased hydraulic fluid conveyance follows at outlet 5 of the hydraulic motor 1 what is compensated according to the invention by a throttle orifice cross section reduction. Thereby it is prevented that drive mechanism 3 of hydraulic motor 1 can rotate freely and reaches a rotational speed being higher than the maximum admissible rotational speed of drive mechanism 3. By the reduction of the orifice cross section the hydraulic motor has to work against this cross section reduction what counteracts against a non-intended respectively unbreak runaway of hydraulic motor 1 respectively of its drive mechanism 3.

Therefore, in a preferred embodiment of the invention the pressure upstream before one of the two throttles 8 or 9 is conducted in such a manner on a throttle orifice spool that its spool reduces the orifice opening of the corresponding orifice. This is shown in FIG. 1 exemplarily with the help of the second orifice 9. If the pressure at outlet 5 of drive mechanism 3 rises, the closing force on throttle orifice spool increases and closes the throttle valve against the force of spring 14, which acts on the throttle orifice spool with a force enlarging the orifice opening. Hence, the pressure being present upstream before the second throttle orifice 9 adjusts the throttle orifice opening in a self-acting manner in conjunction with throttle orifice spring 14. In the embodiment shown in FIG. 1 the throttle orifice opening of the first throttle orifice 8 is exemplarily unchangeable during the operation of hydraulic motor 1. This is shown for simplification reasons, however, also the throttle orifice cross section of the first throttle orifice can be adjustable. This can be performed exemplarily by an actuator which operates or shifts the throttle orifice spool of the first throttle orifice 8 exemplarily hydraulically, electrically, mechanically or electromagnetically or pneumatically.

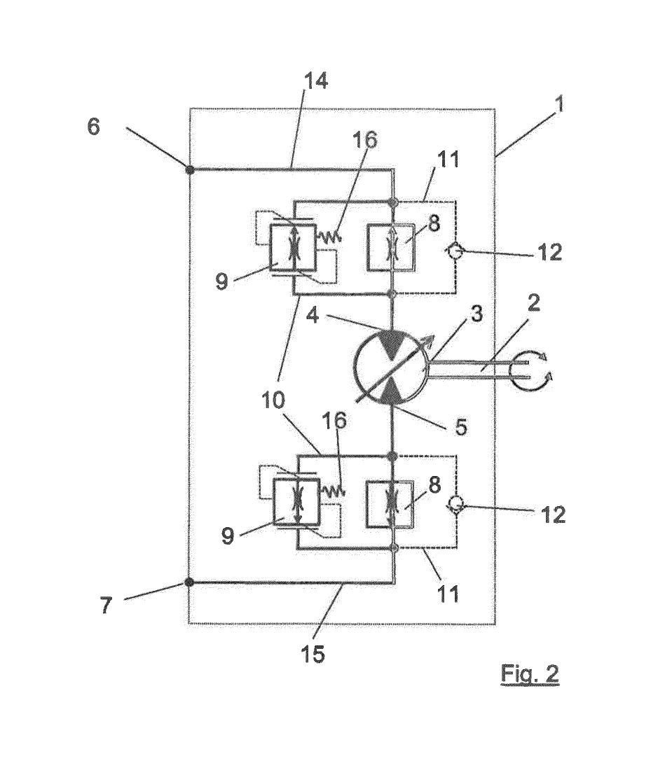

The embodiment of FIG. 2 shows a single side displaceable hydraulic motor 1 whose drive mechanism 3 is operable in both rotational directions by inverting the flow direction in the hydraulic fluid circuit. Thereby according to the flow direction of the hydraulic fluid the high pressure side and the low pressure side, respectively inlet 4 and inlet 5 changing the sides at drive mechanism 3. In order that the inventive arrangement of two parallel throttle orifices on the high pressure side do not lower a power supplied to a hydraulic motor 1 by a hydraulic pump the throttle orifice group at the respective high pressure side 4 can be made inactive. This can be implemented in the embodiment shown in FIG. 2 by the means of two further bypass lines 11, in each of which a check valve 12 is arranged. The bypass lines 11 are shown in dash lines as they are not relevant to the invention, however eventually benefits the power being absorped by the hydraulic motor as the hydraulic fluid flow rate supplied must not or only partly flow over throttle orifices 8 and 9. If such bypass lines 11 are used, according to the invention, at each side of the drive mechanism such a second bypass line 11 comprising a check valve 12 is arranged. The check valve 12 opens and gives free in the respective flow direction the second bypass line, i.e. if the respective side of the drive mechanism is a high pressure side. At the same time, the other check valve arranged in the second bypass line on the low pressure side blocks the same such that the hydraulic fluid flow rate at outlet 5 of drive mechanism 3 is conducted via the inventive throttle orifice arrangement.

By changing the direction of propulsion due to a change in the flow direction the high pressure side is changed also in the hydraulic fluid circuit. The other check valve 12 now arranged on the high pressure side can open and ensure that hydraulic fluid on the high pressure is supplied to the drive mechanism 3 of the work equipment. On the new low pressure side 5 of the drive mechanism 3 the check valve 12 arranged there closes the second bypass line 11 such that the depressurized hydraulic fluid coming from drive mechanism 3 has to flow over throttle orifices 8 and 9 back to the hydraulic pump. As long as a predetermined dynamic pressure is not reached before the second orifice 9 the hydraulic fluid can flow in general without any obstacle through both throttle orifices 8 and 9 back to the hydraulic pump. However, if the rotational drive of drive mechanism 3 sticks due to an increase of the external load on driving shaft 2 and if this external load disappears exemplarily by “breaking free” of the driving shaft abruptly, an exceed conveying volume arises at outlet 5 of the driving mechanism 3 and, as already explained in detail above, which has to be reduced by means of the two throttle orifices 8 and 9 in a controlled manner. In case these conveying volume surpluses, respectively the pressure surpluses would be conveyed unhindered towards the hydraulic pump an overspeeding of the driving mechanism 3 is possible as the same can run away unbreaked. Exactly this is prevented by the invention as the conveying flow dispensed by the hydraulic motor towards the hydraulic pump is throttled, respectively is moderated by the two throttle orifices 8 and 9.

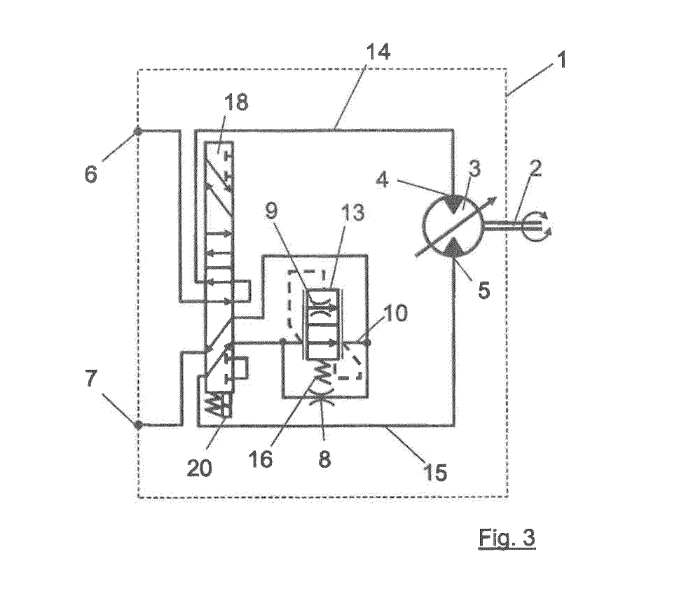

In FIG. 3 a further embodiment for a hydraulic motor having a drive mechanism is shown, which can be driven in both rotational directions. Hereby, according to FIG. 2, the two used second bypass lines 11 with its respective check valves 12 are substituted by only one shuttle valve 18 which is arranged in the hydraulic lines 14 and 15 of the driving mechanism. Thereby in a first switching position, shown in FIG. 3, the cross section for hydraulic fluid towards the drive mechanism 3 in hydraulic line 14 being here a high pressure conducting hydraulic line is possible resistance-less. The hydraulic fluid flow rate in hydraulic line 15 dispensed from drive mechanism 3 to its outlet 5 is conducted in this first switch position over the inventive orifice arrangement. If the flow direction is reversed and therewith also the pressure relations at drive mechanism 3, the shuttle valve 18 can be brought exemplarily by means of an actuator 20 arranged at the same into its second switch position in which hydraulic fluid under high pressure can be conducted unhindered towards drive mechanism 3 and the hydraulic fluid volume dispensed by drive mechanism 3 can be conducted via the inventive orifice arrangement of orifices 8 and 9.

In the embodiment shown in FIG. 3 the second throttle orifice 9 is implemented as proportional shuttle valve 13 which according to the pressure relations before and after the proportional shuttle valves 13 adjusts its orifice opening of throttle 9 in a self-acting way. A spring 16 arranged at proportional shuttle valve 13 presses the throttle valve spool thereby in direction of the maximum open position opposite to the hydraulic force being present at outlet 5 of drive mechanism 3 upstream of the proportional shuttle valve 13.

Resuming, one can say, that the inventive arrangement prevents an unbreaked runaway of a drive mechanism 3 by increasing the flow rate resistance on the low pressure side and, preferred in particular, by controlling the saltational increase of the hydraulic fluid flow. Therewith, in particular, a self-adjusting system is provided which effectively compensates pressure peaks at the drive mechanism and therewith effectively prevents overspeeding of drive mechanism 3 of hydraulic motor 1.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A hydraulic motor for driving a working equipment, with a drive mechanism comprising a high pressure side and a low pressure side whereby on the low pressure side a first throttle orifice and a second throttle orifice within a bypass line which bypasses the first throttle orifice are arranged, whereas at least the orifice opening of the second throttle orifice is adjustable.

2. The hydraulic motor according to claim 1, whose first throttle orifice comprise a fixed orifice opening.

3. The hydraulic motor according to claim 1, in which the second throttle orifice is formed as a metering orifice whose orifice opening, can be closed in the manner of a flow control valve against an elastic force by a pressure after the driving mechanism and before the measuring orifice.

4. The hydraulic motor according to claim 1, in which the orifice opening of the second throttle orifice is adjustable by means of an actuator which is operable mechanically, hydraulically, electrically or pneumatically by means of a control device.

5. The hydraulic motor according to claim 1, whose displacement is adjustable.

6. The hydraulic motor according to claim 1, wherein the hydraulic motor can be operated in both rotational directions.

7. The hydraulic motor according to claim 6, in which on each of both sides of the driving mechanism a first throttle orifice and a second throttle orifice within a bypass line which bypasses the first throttle orifice are arranged, whereas at least the orifice opening of each of the second throttle orifices is adjustable and whereby in each of second bypass lines bypassing the first throttle orifices a check valve is arranged which opens the second bypass line if the corresponding side of the drive mechanism is the high pressure side.

8. The hydraulic motor according to claim 6, in which on each of both sides of the drive mechanism a shuttle valve is arranged, whereby by means of the shuttle valve on the high pressure side an outlet for hydraulic fluid towards the drive mechanism is completely releasable and by means of the shuttle valve on the low pressure side the first or the second throttle orifice can be activated.

9. The hydraulic motor according to claim 1, whereby the hydraulic motor drives a drill string.

10. The hydraulic motor according to claim 1, whereby the hydraulic motor is realized as an axial piston motor or a radial piston motor.

11. A hydrostatic drive with a hydraulic motor according to claim 1, whereby the hydrostatic drive comprises an open or a closed hydraulic fluid circuit.

12. The hydraulic motor according to claim 2, in which the second throttle orifice is formed as a metering orifice whose orifice opening, can be closed in the manner of a flow control valve against an elastic force by a pressure after the driving mechanism and before the measuring orifice.

13. The hydraulic motor according to claim 2, in which the orifice opening of the second throttle orifice is adjustable by means of an actuator which is operable mechanically, hydraulically, electrically or pneumatically by means of a control device.

14. The hydraulic motor according to claim 2, whose displacement is adjustable.

15. The hydraulic motor according to claim 3, whose displacement is adjustable.

16. The hydraulic motor according to claim 4, whose displacement is adjustable.

17. The hydraulic motor according to claim 2, where the hydraulic motor can be operated in both rotational directions.

18. The hydraulic motor according to claim 3, where the hydraulic motor can be operated in both rotational directions.

19. The hydraulic motor according to claim 4, where the hydraulic motor can be operated in both rotational directions.

20. The hydraulic motor according to claim 5, where the hydraulic motor can be operated in both rotational directions.
